(19) United States
(12) Patent Application Publication
(10) Pub. No.: US 2009/0210233 A1
(43) Pub. Date: Aug. 20, 2009

(54) COGNITIVE OFFLOADING: INTERFACE FOR STORING AND COMPOSING SEARCHES ON AND NAVIGATING UNCONSTRAINED INPUT PATTERNS

(75) Inventors: Ralph Donald Thompson, III, Sammamish, WA (US); Russell I. Sanchez, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/031,967

(22) Filed: Feb. 15, 2008

(51) Int. Cl. G10L 15/00

(52) U.S. Cl. 704/275; 704/E15.001

(57) ABSTRACT

One or more commands are configured to cause content to be stored for retrieval. The content to be stored includes one or more entries. The content may include event-triggered content stored for retrieval upon an occurrence of a specified event or other content. The content is retrieved in response to a retrieval command specifying a given pattern by comparing the given pattern with the stored content and, upon finding a match for the given pattern, wherein the match corresponds with the given pattern within a predetermined variance, retrieving additional content stored with the match for the given pattern. The content also may be retrieved by identifying the occurrence of the specified event and retrieving the event-triggered content upon the occurrence of the specified event.

### BACKGROUND

The amount of information that individuals need to remember or keep track of seems to be growing continually. For example, it was not long ago that contact information for an acquaintance included, at most, home and office telephone numbers and home and office addresses. Today, however, in addition to those four pieces of information, most individuals also have a mobile telephone number, a fax number, and an e-mail address, if not multiple mobile telephone numbers, fax numbers, and e-mail addresses.

To try to keep track of this information, individuals use pen and paper, computer database programs on computers, electronic organizers, and voice recorders. These implements allow for information to be stored. Unfortunately, storing information in these implements is not always convenient. Textual entry, whether electronically or by hand, is time consuming. In addition, to cite one example, it is dangerous and/or illegal to enter information in these implements while driving an automobile (with the possible exception of a voice recorder). Unfortunately, by the time the driver reaches his or her destination, he or she may have forgotten the information that the user previously had wanted to record.

Furthermore, even if one were able to capture and maintain all of this information in a notebook, an organizer, a voice recorder, or a database and were willing to carry that implement around, retrieving the information may be still prove difficult. Generally, electronic organizers and databases are structured to allow for relatively easy retrieval of telephone numbers and addresses. Unfortunately, these automated organization tools prove not to be helpful if the information was not logged under the correct—and correctly spelled—name or the user cannot later remember under what name or what spelling to search for the contact information. Furthermore, these automated organization tools are not well designed for the storage and retrieval of less formal types of information, such as book recommendations, restaurant suggestions, gift ideas, and shopping lists. Even if a user were to create an entry to store this information under an appropriate name or other index entry, it may be as hard to remember what that index was (e.g., was it under “book recommendation,” “reading recommendation,” “recommendation for book,” or another index?) to subsequently find that entry as it would be to try to remember the information.

Other memory aids, such as recorders and notebooks, also may not be helpful. For example, information recorded on a voice recorder can be difficult to locate. Even if a user separately records reminders and carefully organizes them into folders, it may be very difficult to later find the desired entry in the desired folder. As far as handwritten information, even if a user is able to find the correct page in a notebook where the information was logged, many individuals cannot later read or make sense of even their own handwritten notes.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure is directed to computer-implemented methods, computer-readable media, and systems for cognitive offloading. One or more commands are configured to cause content to be stored for retrieval. The content to be stored includes one or more entries. The content may include event-triggered content stored for retrieval upon an occurrence of a specified event or other content. The content is retrieved in response to a retrieval command specifying a given pattern by comparing the given pattern with the stored content and, upon finding a match for the given pattern, wherein the match corresponds with the given pattern within a predetermined variance, retrieving additional content stored with the match for the given pattern. The content also may be retrieved by identifying the occurrence of the specified event and retrieving the event-triggered content upon the occurrence of the specified event.

These and other features and advantages will be apparent from reading the following detailed description and reviewing the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

In the drawings, like numerals represent like elements. The first digit in each of the three-digit reference numerals refers to the figure in which the referenced element first appears.

FIG. 1 is a block diagram of a generalized computing operating environment facilitating implementations of computer-implemented methods, computer-readable media, and systems for cognitive offloading as herein described;

FIG. 2 is block diagram of exemplary contexts for deploying implementations of cognitive offloading;

FIG. 3 is a block diagram depicting a plurality of content entries;

FIG. 4 is a block diagram depicting the clustering of content entries partially matching given patterns presented in a search request;

FIG. 5 is a flow diagram of a process for entering content; and

FIG. 6 is a flow diagram of a process for searching for and retrieving content.

### DETAILED DESCRIPTION OF IMPLEMENTATIONS

This detailed description describes implementations of cognitive offloading. In one implementation, cognitive offloading operates in a verbal interface. Notwithstanding, cognitive offloading prompting is applicable in any context in which content may be stored and searched to provide for retrieval of the content.

Implementations of cognitive offloading allow a user to reliably store information in a receptacle from which the information can be easily retrieved on demand or will cause a reminder to be generated upon the occurrence of a specified event. In this way, the user need not concern himself or herself with trying to remember various pieces of information. Cognitive offloading is also easy to use. In a verbal interface-based implementation, a user need only speak what the user wishes to store and later speak again to retrieve the information. The storage and retrieval processes do not require keyboard or handwritten entries, so it is easy to do even when the user's eyes and/or hands are otherwise occupied. Also, because information stored is searched based on patterns, retrieval is not dependant upon exactly recalling an index or key under which the information is stored, but on matching a given pattern against stored content to find content matching the given pattern within a predetermined variance.

More specifically, in one implementation, cognitive offloading allows a user to verbally activate a device that will respond to verbal commands. The verbal commands allow the user to store auditory content that the user later wants to remember, such as a shopping list. By later initiating a retrieval command providing a pattern associated with the previously stored content, for example, upon receiving the search term “shopping list,” the system searches stored content for the pattern “shopping list.” Upon finding a match for the “shopping list” pattern, auditory content stored with the match for the given pattern “shopping list” will be retrieved and presented to the user. In one implementation, the auditory content of the shopping list, which, for example, may be digitized and stored as a digital representation of the original auditory content, will be audibly played back.

Implementations of cognitive offloading also allow for auditory content to be stored in association with a specified event. Then, when an occurrence of the specified event occurs, the associated content will be retrieved or played back to the user. For example, if the user stored auditory content such as “remember to get bread on the way home” and associated that auditory content with the event 5:00 p.m., at 5:00 p.m., the stored auditory content would be retrieved and presented for the user. Such event-driven retrieval may be triggered by any event the system is able to detect. For example, if the system has an on-board clock, auditory content can be set for retrieval after the passage of a specified period of time (e.g., “remind me to turn off the sprinkler in 10 minutes”) or at a specified time, including a specified time of day and/or a date (e.g., “remind me to call Dad at 7:00 p.m.,” “remind me to call the bank Monday at 9:00 a.m.,” or “remind me to wish Linda a happy birthday on July 11”). Correspondingly, if the system has access to additional sensor or a detection devices, the event-driven retrieval may be associated with any event such devices can detect. Just to list a few examples, if the system includes a telephone or a telephone earpiece operable to receive caller identification information, auditory content can be set for retrieval and playback when a person at a certain telephone number should next telephone the user. Similarly, if the system includes or has access to a Global Positioning System (GPS) device, locations could be associated with auditory content so that arriving or nearing a particular location will trigger retrieval of the stored content. Further, if the system has network access to RSS or other information streams, auditory information with phrases or topics, such as financial announcements or sporting event results, may cause the retrieval the of the stored content.

Operation and variations of cognitive offloading are explained in detail below.

### Illustrative Operating Environment

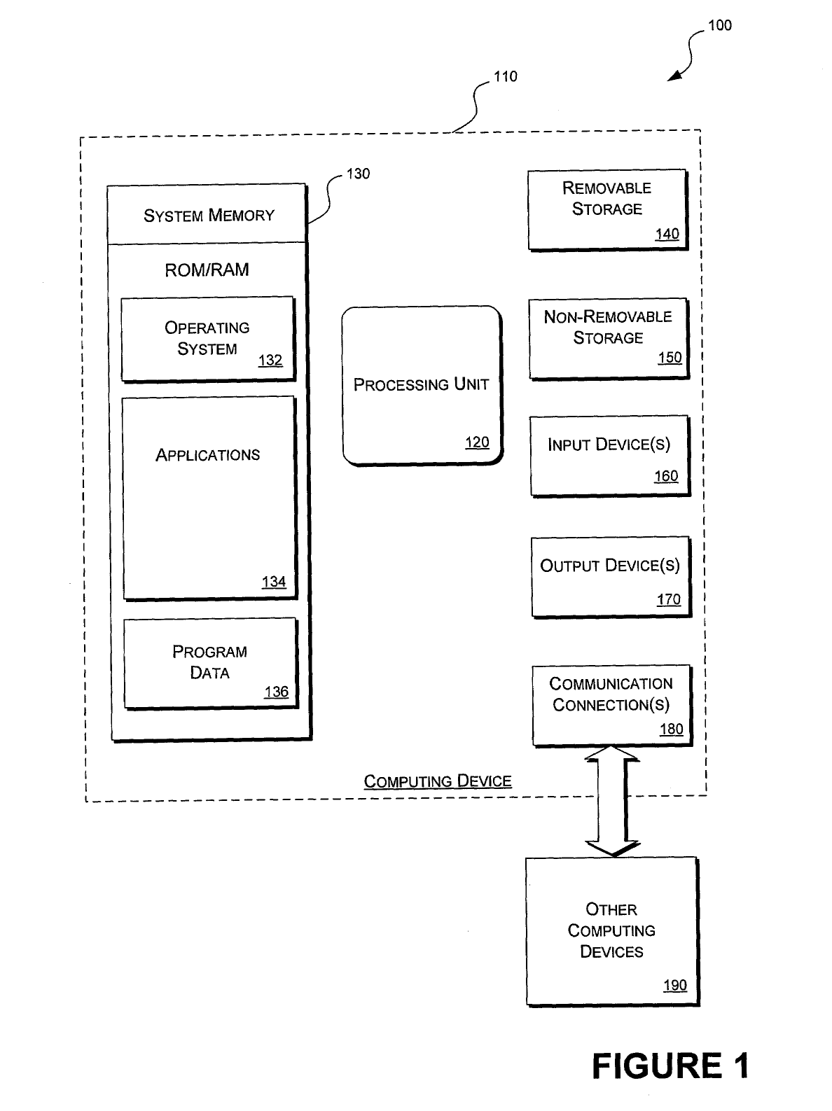

Implementations of cognitive offloading may be supported by a number of different computing environments. FIG. 1 is a generalized block diagram of a representative operating environment 100.

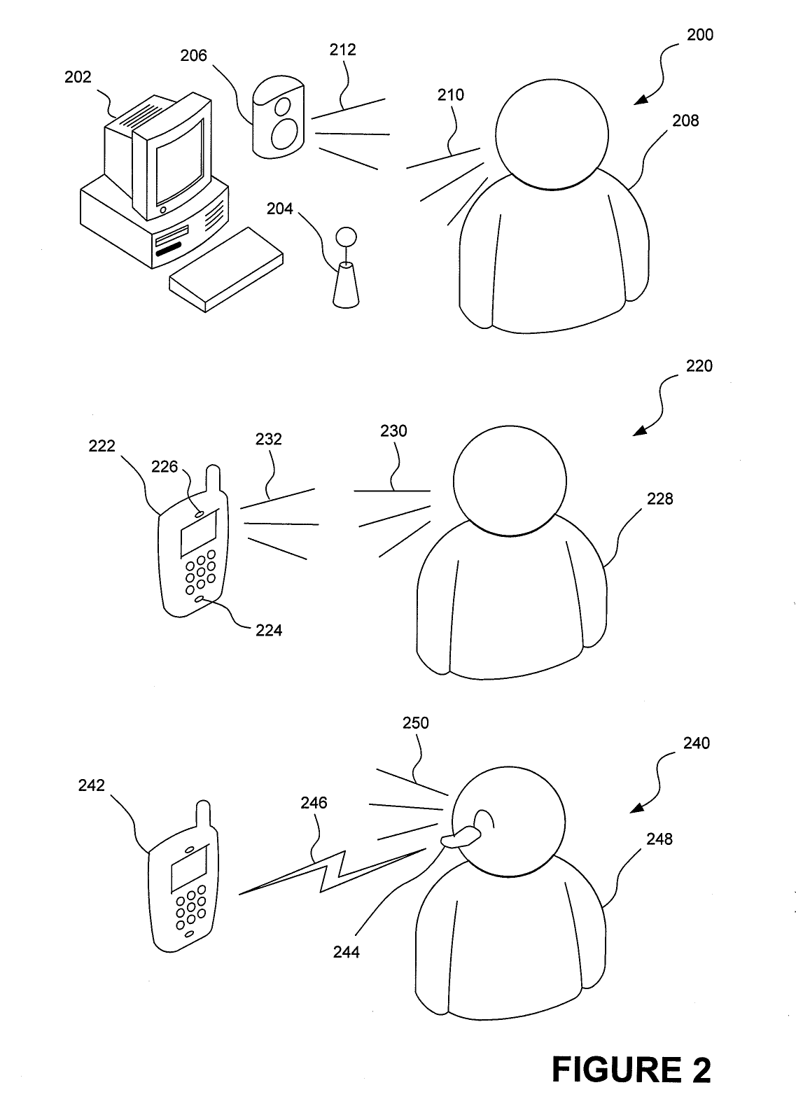

Referring to FIG. 1, an exemplary operating environment 100 includes a computing device, such as computing device 110. In a basic configuration, the computing device 110 may include a stationary computing device, a mobile computing device, or an earpiece-mounted device, as further described with reference to FIG. 2. The computing device 110 typically includes at least one processing unit 120 and system memory 130. Depending on the exact configuration and type of computing device, the system memory 130 may be volatile (such as random access memory or “RAM”), non-volatile (such as read-only memory or “ROM,” flash memory, and similar memory devices that maintain the data they store even when power is not provided to them) or some combination of the two. The system memory 130 typically includes an operating system 132, one or more applications 134, and may include program data 136.

The computing device 110 may also have additional features or functionality. For example, the computing device 110 may also include removable and/or non-removable additional data storage devices such as magnetic disks, optical disks, tape, and standard-sized or miniature flash memory cards. Such additional storage is illustrated in FIG. 1 by removable storage 140 and non-removable storage 150. Computer storage media may include volatile and/or non-volatile storage and removable and/or non-removable media implemented in any method or technology for storage of information such as computer-readable instructions, data structures, program modules or other data. The system memory 130, the removable storage 140 and the non-removable storage 150 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 110. Any such computer storage media may be part of the device 110. The computing device 110 may also have input device(s) 160 such as a keyboard, mouse, pen, voice input device, touch input device, etc. Output device(s) 170 such as a display, speakers, printer, etc. may also be included.

The computing device 110 also contains one or more communication connections 180 that allow the device to communicate with other computing devices 190, such as over a wired or a wireless network. The one or more communication connections 180 are an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Not all of the components or devices illustrated in FIG. 1 or otherwise described in the previous paragraphs are necessary to support cognitive offloading. For example, a handheld or wearable device may include a single system memory 130 comprised of a flash memory configured to store an operating system, one or more applications, and all program data. A compact device may or may not include removable storage 150. In addition, the communication connection 180 may include only a Bluetooth® radio transceiver and/or a Universal Serial Bus (USB) connection port for backup, update, and networking functions.

Exemplary Environment for Using Cognitive Offloading with Verbal Interfaces

FIG. 2 illustrates three sample operating environments in which cognitive offloading might be employed using a verbal interface. A computer-based environment 200 includes a computer 202, which may be a desktop, laptop, notebook, or palmtop computer. The computer 202 may be equipped with one or more microphones 204 to receive auditory input and one or more speakers 206 to issue verbal prompts and confirmations and provide other auditory information. The microphone 204 and speaker 206 may be peripherals of the computer 202 with wired or wireless connections with the computer 202.

In a non-portable environment, multiple microphones 204 and speakers 206 may be disposed throughout a room, office, home, or other user environment to facilitate verbal interaction with the computer 202. One or more microphones 204 and speakers 206 may be located remotely from the computer 202 to allow the user 208 to interact with the computer via the verbal interface without the user being in close proximity to the computer. Alternatively, in a portable environment, the microphone 204 and one or more speakers 206 may be integrated within the computer 202 (not shown in FIG. 2). Further alternatively, the microphone 204 and one or more speakers 206 may be included in a wired or wireless headset (not shown in FIG. 2) worn by a user 208.

The user interacts with the computer by providing auditory input 210 including, for example, verbal commands and other auditory content to the computer 202 via the microphone 204 and receiving auditory information 212 from the computer 202 via the speaker 206. Implementations of cognitive offloading control the auditory information 212 provided by the computer 202 in response to the auditory input 210 as will be described below.

A portable environment 220 also may support implementations of cognitive offloading. In an exemplary portable environment 220, a portable computing device 222, such as a personal digital assistant (PDA), a handheld personal computer, or a mobile telephone (as shown in (FIG. 2) is configured to support cognitive offloading. In the exemplary portable environment 220, a user 228 provides auditory input 230 to the portable computing device 222 which receives the auditory input via a microphone 224 and receives prompts and other auditory information 232 via a speaker 226.

A wearable environment 240 also may support implementations of layered cognitive offloading. In an exemplary wearable environment 240, a user employs a wearable device 244 configured to receive auditory information 250 from the user via a built-in microphone and present prompts and other auditory information via a built-in speaker. The wearable device 244 may take the form of a wired or wireless earpiece or headset of the type used with a wired telephone or a mobile device 242 such as a mobile telephone, and a portable music player or other devices.

In the wearable environment 240, the wearable device 244 may be a standalone device configured to assist the user in information storage and retrieval and other functions as described below. The wearable device 244 may support these functions in addition to serving as a headset for another device such as the mobile device 242. The wearable device 244 may communicate with the mobile device 242 through a wired connection or a wireless connection 246. When the wearable device 244 is configured to communicate with the mobile device 242, layered prompting and other storage and retrieval applications for auditory information may be supported within the wearable device 244, on the mobile device 242 (wherein the wearable device 244 serves as a microphone and a speaker for the user 248), or by some combination of the wearable device 244 and the mobile device 242.

### Illustrative Examples of Cognitive Offloading Functions

As previously mentioned, implementations of cognitive offloading allow a user to initiate a cognitive offloading function, such as by speaking a command and listing the arguments for the command. In this manner, information can be easily stored and later retrieved. Operation of implementation is described in the context of the following examples.

Consider a case in which a user wants to reliably store four pieces of information:
1. Shopping list for dinner with Pat: wine, steaks, bread, salad, dessert
2. Book recommendations from Pat: Night Fall and Wild Fire
3. Restaurant recommendations from Pat: The Village Pub
4. Get to bank before it closes—reminder at 5:00.
   Using cognitive offloading, all four items can be stored using storage commands.

In one implementation of a cognitive offloading system, the interface is entirely verbal. To initiate the system, a wakeup word, such as “System” alerts the system to prepare to receive auditory input. Practically, one may wish to select a keyword that is less likely to arise during ordinary conversation than “system.” The system may answer the wakeup word with an acknowledgment ranging from a beep to a verbal acknowledgment, such as “Yes?” or “Ready.” The user then initiates storage with a storage command, such as a “remember” command.

Alternatively, implementations of cognitive offloading also may include one or more physically-actuated switches, such as mechanical or electrical switches or buttons. Thus, instead of a wakeup word, a user might press a button or otherwise actuate a switch to activate the system. Similarly, instead of voice commands to initiate the storage or retrieval of information, the system may provide one or more buttons to cause information to be stored, stored in association with occurrence of a specified event, and retrieved.

In one implementation configured to respond to a wakeup word and verbal commands, the remember command stores auditory content following the issuance of the remember command. Thus, to store the shopping list, including the wakeup word, the command would proceed as follows:

| | |
|---|---|
| User: | System? |
| System: | Ready |
| User: | Remember shopping list for dinner with Pat, wine, |
| | steaks, bread, salad, dessert. |
| User: | <Pause> |
| System: | Got it. |

With this command complete, the content following the command, remember, is stored as data. Similarly, the user can store the other items in the list by invoking the wakeup word, giving the remember command, and stating what the user wants to remember. As described below, implementations of cognitive offloading may recognize short pauses in a list that, for example, manifest the commas in the shopping list, into separate or sub-entries to facilitate separate retrieval and manipulation of such entries, as well as navigation between these entries or sub-entries.

Implementations of cognitive offloading also may include variations and enhancements. For example, while the user is providing auditory content, the system may ask “Anything else?” to encourage the user to continue. For example, the process of storing the second item to be remembered, the book recommendations, might proceed as follows:

| | |
|---|---|
| User: | System? |
| System: | Ready |
| User: | Remember book recommendations from Pat, Night Fall. |
| User: | <Pause> |
| System: | Anything else? |
| User: | Yes. |
| System: | Go ahead. |
| User | Wild Fire. |
| User: | <Pause> |
| System: | Got it. |

In one implementation of cognitive offloading, the first pattern given after the command such “book recommendations from Pat” is taken as an implied subject. By prompting the user “Anything else,” although the user did not first include both book recommendations from Pat, the user subsequently remembered to include both recommendations. Also, because the second recommendation followed the “Anything else?” prompt that followed as part of the same remember command, both book recommendations are joined to the implied subject.

Null speech, such as “um” or “er” may be suppressed and not stored. This not only saves storage capacity, but it eliminates the risk of later retrieving may be irrelevant information just because the user happened to “um” in storing the desired entry as well as other irrelevant entries. For example, in storing the third entry, the remember command may proceed as follows:

| | |
|---|---|
| User: | System? |
| System: | Ready |
| User: | Remember restaurant recommendations from Pat, |
| | umm, The Village Pub |
| User: | <Pause> |
| System: | Anything else? |
| User: | <Pause> |
| System: | Got it. |

In one implementation, the “umm” is not stored—it is removed from the content and thus will not lead to spurious retrievals later.

The remember command is a storage command that will allow the information to be retrieved by the user as explained below. In addition, it may be desirable to cause information to be stored in association with an event. Implementations of cognitive offloading provide this feature with a different command, such as a “remind me” command.

For example, the fourth item the user wished to remember was tied to an event: the user wanted to remember to get to the bank before it closed with a reminder at 5:00 p.m. Entering a remind me command that associates the entry with an event may proceed as follows:

| | |
|---|---|
| User: | System? |
| System: | Ready |
| User: | Remind me, get to the bank before it closes |
| User: | <Pause> |
| System: | When do you want to be reminded? |
| User: | At 5:00 p.m. |
| User: | <Pause> |
| System: | Got it. |

The “remind me” command associates the entry, get to the bank before it closes, with an event: 5:00 p.m. Thus, when the system clock reaches 5:00 p.m., the auditory content “get to the bank before it closes” will be played back to provide a reminder for the user.

The remind me command can be used to cause retrieval of the stored information upon the system identifying an occurrence of the event. Using the system clock, the system initiates retrieval of information at a specified time, in a specified number of hours or minutes, on a particular date, etc. Additionally, stored information can be associated with many other events that can be detected. For example, if the cognitive offloading system is associated with a telephone or a telephone earpiece to which caller identification information is available, a user could leave a reminder for the next time that person called. For example, the user can employ the remind me command to ask Jim about their postponed dinner plans the next time Jim calls. Then, when Jim's telephone number appears on the caller identification system, the stored content or information about the postponed dinner plans is retrieved and played back to the user.

There is no limit to what sensors may be used to identify events and generate reminders using cognitive offloading. If the device is portable and includes or has access to a local GPS device, a reminder could be left for the next time the user is at a certain location, such as a specified store, residence, or other location. Implementations of cognitive offloading may have access to address books or a network. Thus, when the user leaves a reminder for the next time the user is at “Mom and Dad's house” or the next time the user is at the “warehouse club,” the system can identify the location of those places. Then, when the GPS device determines that the user is at that location, the system retrieves and generates the associated reminder.

Cognitive offloading also may include atmospheric or environmental sensors to measure temperature, humidity, barometric pressure, altitude, humidity, and other ambient factors to set up events to trigger reminders, such as the calling a friend to get back a lawn mower on the next day it is over fifty degrees.

Cognitive offloading also may use biometric sensors to measure a user's core temperature, heart rate, pulse, and other such quantities to trigger reminders. Also, with a voice or image recognition sensor, a user could leave reminders for a next time the user runs into a specified person for whom a voice record or an image record may be present and appropriate sensors can identify that person's presence.

In addition, cognitive offloading may also be responsive to information that is broadcast or presented on a network, such as RSS feeds or other feeds, to trigger reminders. For example, a user could associate a stored reminder with an element of information included in information the system is configured to receive, such as a reminder to sell a particular company's stock when the share price reaches a threshold set by the user.

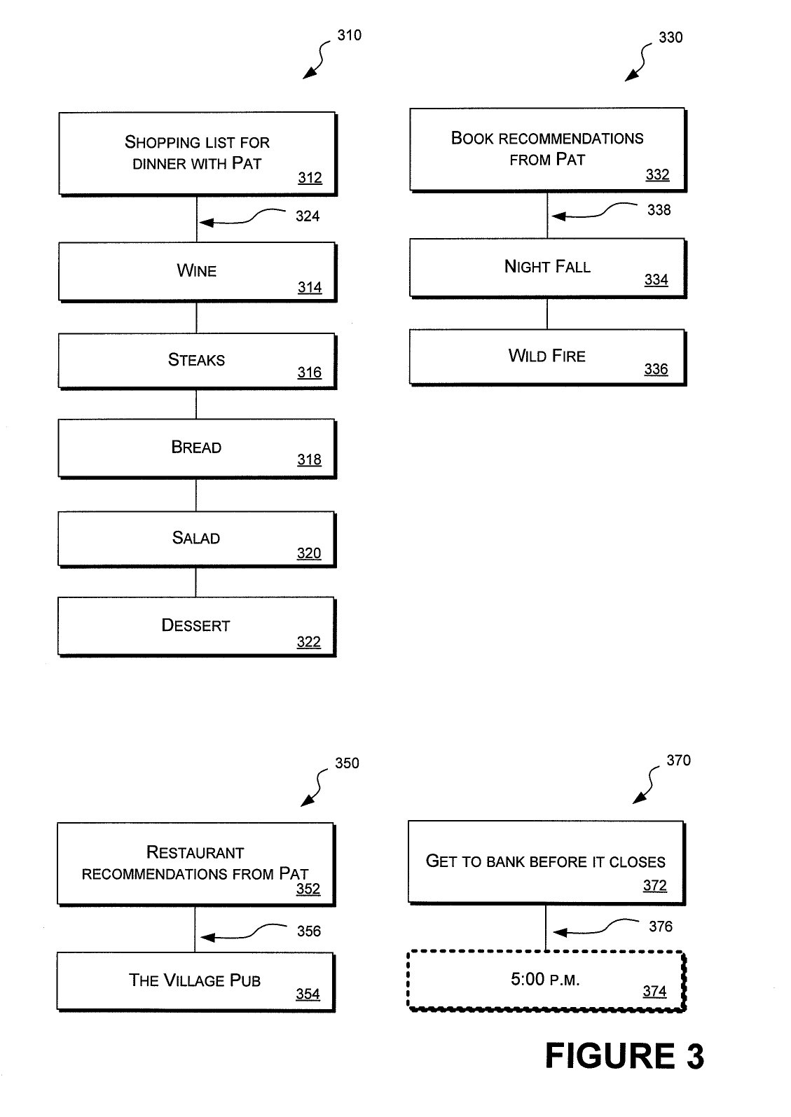

FIG. 3 shows a block diagram of the result of the stored information after the four storage commands have been executed. Entry 310 is the first entry regarding the shopping list. The first entry presented, shopping list for dinner with Pat 312, is a sub-entry that serves as the implied subject of the complete entry. It is associated with the other sub-entries, wine 314, steaks 316, bread 318, salad 320, and dessert 322. The sub-entries are joined as part of the same entry 310 by a link 324. Thus, as explained below, when the user retrieves the entry 310 for shopping list with Pat, each of the sub-entries are connected to the list. However, being separate sub-entries, each is navigable and manipulable as a separate data entry, as also will be explained below.

A second entry 330 represents the storage of book recommendations from Pat 332, in which sub-entries Night Fall 334 and Wild Fire 336 are joined by a link 338. A third entry 350 stores the sub-entries the restaurant recommendation from Pat 352 and the Village Pub 354, joined by link 356.

The fourth entry 370 stores the sub-entry get to bank before it closes 372. However, instead of being associated with another sub-entry, the sub-entry 372 is joined by a link 376 to an event, 5:00 p.m. 374. The event 374 was associated with the sub-entry 372 by using a remind me command instead of a remember command. As a result, when the event, 5:00 p.m., is detected, the sub-entry 372 is retrieved and presented to the user without the user having to search for the sub-entry 372.

It is important to note that the entries and sub-entries are stored as presented, albeit, in one implementation, in a digitized format. The content is not converted to text. The cognitive offloading system does not perform speech-to-text recognition or otherwise transform the information. Thus, among other benefits, implementations of cognitive offloading are not language-dependent. A user could issue commands in any language supported in acknowledging commands but, regardless of the command language, the user could store content and search for matching content in any language. In fact, the content need not conform to any known language—the stored content and the given pattern for which the stored content is stored may be any representable information, including noises, make-believe languages, or any other content.

In addition, it should be appreciated that the matching of a given pattern against the stored content is not limited to seeking exact matching. The given pattern may cause content to be retrieved as long as the content matches within a predetermined variance. The variance may be established by a percentage or any other unit of variance recognized or recognizable by one skilled in matching given patterns against a body of data.

Generally, search commands receive a pattern, attempt to match that pattern with stored content, and retrieve entries and sub-entries with matching content. For example, a search command precedes a search string, which is perceived and used as a given pattern to be matched against stored content. Use of a search command may proceed as follows:

| | |
|---|---|
| User: | System? |
| System: | Ready |
| User: | Search for shopping list |
| System: | [Replaying originally recorded content] “Shopping list |
| | for dinner with Pat, wine, steaks, bread, salad, desert” |

The system takes the search terms, which it takes as a given pattern, and searches through the stored entries for a match. In this case, there is only one entry that has information matching the given pattern, the shopping list entry. Thus, the system retrieves and plays back the information for the shopping list for dinner with Pat. Retrieved entries are presented or played back from their originally recorded content as signified in the previous and the foregoing examples by the insertion of quotation marks. System prompts or other system information is presented in the system's voice as signified by the lack of quotation marks.

The search commands may include a number of features and variations. For example, the search commands may employ phrase elimination. In other words, the user may not want or need to hear the search terms the user just provided read back to him. Thus, the given pattern presented by the search terms would be suppressed in the presentation of the retrieved content as follows:

| | |
|---|---|
| User: | System? |
| System: | Ready |
| User: | Search for shopping list |
| System: | “for dinner with Pat, wine, steaks, bread, salad, desert” |

If the user had been more specific in presenting the search terms, phrase elimination would remove other repeated content as follows:

| | |
|---|---|
| User: | System? |
| System: | Ready |
| User: | Search for shopping list for dinner with Pat |
| System: | “wine, steaks, bread, salad, desert” |

The search commands also may present retrieved content sub-entry by sub-entry so that the reader does not have to try to keep replaying the entirety of the retrieved information or have to try to re-assimilate all the information in the list as it is played back. The search commands thus may invoke navigation functions to allow the user to move between the subentries in the list. The user also can employ action commands to act on these items. Using these navigation functions and action commands (with phase suppression), the retrieval may be presented as follows:

| | |
|---|---|
| User: | System? |
| System: | Ready |
| User: | Search for shopping list |
| System: | “for dinner with Pat” |
| User: | Next |
| System: | “wine” |
| User: | Next |
| System: | “steaks” |
| User: | Next |
| System: | “bread” |
| User: | Previous |
| System: | “steaks” |
| User: | <With the user remembering that Pat does |
| | not eat red meat> Delete |
| System: | “Are you sure? |
| User: | Yes |
| System: | “steaks” deleted |
| User: | Next |
| System: | “bread” |

Thus, the user not only can retrieve a list of entries, but can navigate through and act on the entries and sub-entries. The user can delete entries, insert new entries, etc. Thus, in the foregoing example, the user could replace the sub-entry “steak” with “chicken” to account for Pat's preferences.

In the preceding example, because the implied subject entry shopping list for dinner with Pat 312 was presented as a single entry, the system presents the entry as a single entry. On the other hand, because the shopping list items, such as wine, steaks, etc., were presented as a list delimited by pauses, the sub-entries can be treated separately using navigation commands, action commands, etc.

### Retrieval of Multiple Entries

Implementations of cognitive offloading are configured to support the user when a search returns multiple entries. For example, with reference to the foregoing examples and FIG. 3, a search for the pattern “Pat” would retrieve two entries 310 and 330. One can imagine that if Pat were the spouse, child, business partner or other person significant in the user's life, a search on that name would return a great many entries. Implementations of cognitive offloading therefore support retrieval of multiple entries to aid the user.

To respond to retrieval of multiple entries, implementations of cognitive offloading support features including list prioritization, numbering, clustering, and truncating. Using list prioritization, when the given pattern presented as the search terms partially matches multiple entries, the entries are prioritized according to which presents the greatest number of matches. Prioritization of such a list might be presented as follows:

| | |
|---|---|
| User: | System? |
| System: | Ready |
| User: | Search for Pat, recommendations, restaurant |
| System: | There are two entries |
| User: | Next |
| System: | “Restaurant recommendations from Pat” |
| User: | Next entry |
| System: | “Book recommendations from Pat” |

The cognitive offloading system first presented the restaurant recommendations from Pat entry 350 before the book recommendations from Pat entry 330 because the former matched three entries in the given pattern or search terms, recommendations, restaurant, and Pat. By contrast, the latter entry 330 matched only two of the portions of the given pattern, recommendations and Pat. Implementations of cognitive offloading assist the user with relevance prioritization. It should be noted that implementations of cognitive offloading allow for navigation between sub-entries or navigation between entries as presented in the foregoing example.

To further assist the user in navigating between entries, implementations of cognitive offloading also may assign numbers to the entries. In one implementation, numbers are assigned according to relevance prioritization, although the numbers could be assigned on the basis of which entries are the more recent or on another basis. Using numbering, the retrieval operation may be presented as follows:

| | |
|---|---|
| User: | System? |
| System: | Ready |
| User: | Search for Pat, recommendations, restaurant |
| System: | There are two entries |
| User: | Next |
| System: | Entry One: “Restaurant recommendations from Pat” |
| User: | Next |
| System: | “The Village Pub” |
| User: | Next |
| System: | Entry Two: “Book recommendations from Pat” |
| User: | Go to Entry One |

Thus, the user can navigate using the assigned numbers. The greater the number of items retrieved, the more helpful such numbering may be. In the foregoing example, the entry numbers are presented in the voice of the system, as are the other system prompts. The actual entries are presented in the originally recorded content.

As multiple entries are retrieved, presenting truncated versions of the list may be convenient for the user. The cognitive offloading system may read only an initial portion of each entry, allowing the user to preview the multiple entries before selecting one. Using both numbering and truncation, such a retrieval operation may be presented as follows:

| | |
|---|---|
| User: | System? |
| System: | Ready |
| User: | Search for Pat |
| System: | There are three entries |
| User: | Next |
| System: | Entry One: “Shopping list . . . “ |
| User: | Next |
| System: | Entry Two: “Book recommendations . . . ” |

If the user realized he was looking for the book recommendations, it would save the user time in not having to listen to the entirety of the shopping list entry. This is a simplified example, but one can imagine, with more and longer entries being retrieved, that it would be helpful to not be presented with complete entries. Truncation may be applied once the number of entries surpasses a threshold number of entries and/or when one or more of the entries exceeds a predetermined duration. Truncation stops the playback of entries after an established playback duration. In addition to entry truncation, implementations of cognitive offloading also allow a user to interject a command to stop playback of an entry, interrupt to instruct the system to proceed to a next entry, and similar commands.

Clustering is employed when a retrieval operation identifies a great number of entries that partially match the given pattern presented in the search terms. Clustering may become particularly useful when the total number of entries includes dozens of entries and may be triggered by a threshold number of entries retrieved. In an attempt to usefully present the clusters of partial matches, the system identifies how many partial matches are represented in each cluster.

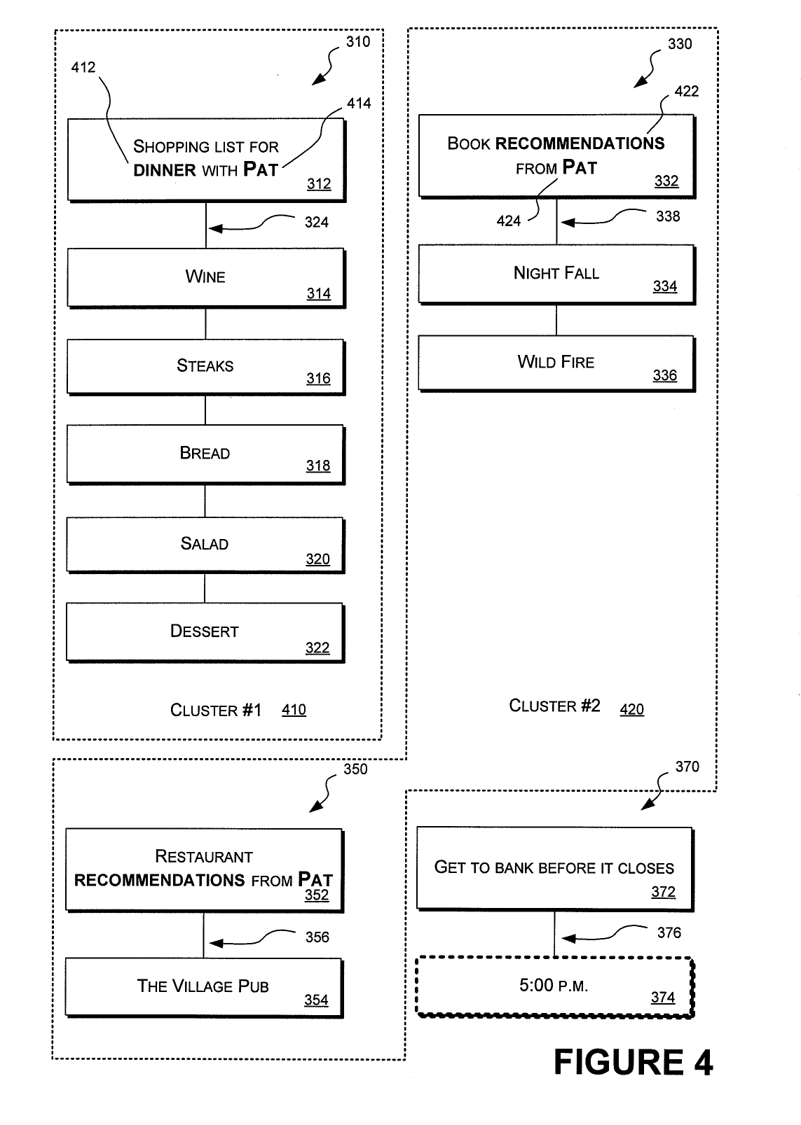

Although clustering may not be practical using only the current examples of FIG. 3, the current examples illustrate how clusters might be presented generally. Assuming there are a total of dozens of shopping lists for dinner with Pat, book recommendations from Pat, and restaurant recommendations from Pat, a search for dinner recommendations from Pat will result in two clusters being grouped as shown in FIG. 4.

FIG. 4 groups the entries 310, 330, and 350 of FIG. 3 using dotted lines into two clusters: cluster 1 410 and cluster 2 420. Cluster #1 410 includes entry 310 which, from the given patterns “Pat,” “dinner,” and “recommendations” presented by the search terms, matches two content entries: dinner 412 and Pat 414. Cluster #2 420 includes entries 330 and 350 which, from the given patterns presented by the search terms, match two content entries: recommendations 422 and Pat 424. Assuming there are many such entries in each of the clusters 410 and 420, the clustered response to the search request may be presented as follows:

| | |
|---|---|
| User: | System? |
| System: | Ready |
| User: | Search for Pat, dinner, recommendations |
| System: | There are a large number of entries with partial matches. |
| | Shall I present the entries in clusters? |
| User: | Yes |
| System: | Cluster One: Matches with “Pat” and “dinner” |
| User: | Next |
| System: | Cluster Two: Matches with “Pat” and “recommendations” |

Thus, confronted with a large number of entries with partial matches, a user can choose which of the partially-matching cluster or clusters to consider first, or if the user wishes to consider any of them.

The prioritization of the clusters in this example was based on the order of the search terms. In other words, Cluster #1 410 was presented first because its entry included the first two terms, Pat and dinner, in the search terms Pat, dinner, and recommendations. On the other hand, the entries in Cluster #2 420 matched the second and third terms, dinner and recommendations. Other methods of prioritization may be employed. When one cluster includes more matching terms than other clusters, it would be natural to list that cluster first. When the number of matching terms is equal, however, as in the foregoing example, clusters could be ordered according to which had the longer matches, by which cluster included a greater number of recent entries, or any other desired prioritization scheme.

### Exemplary Operation of Cognitive Offloading

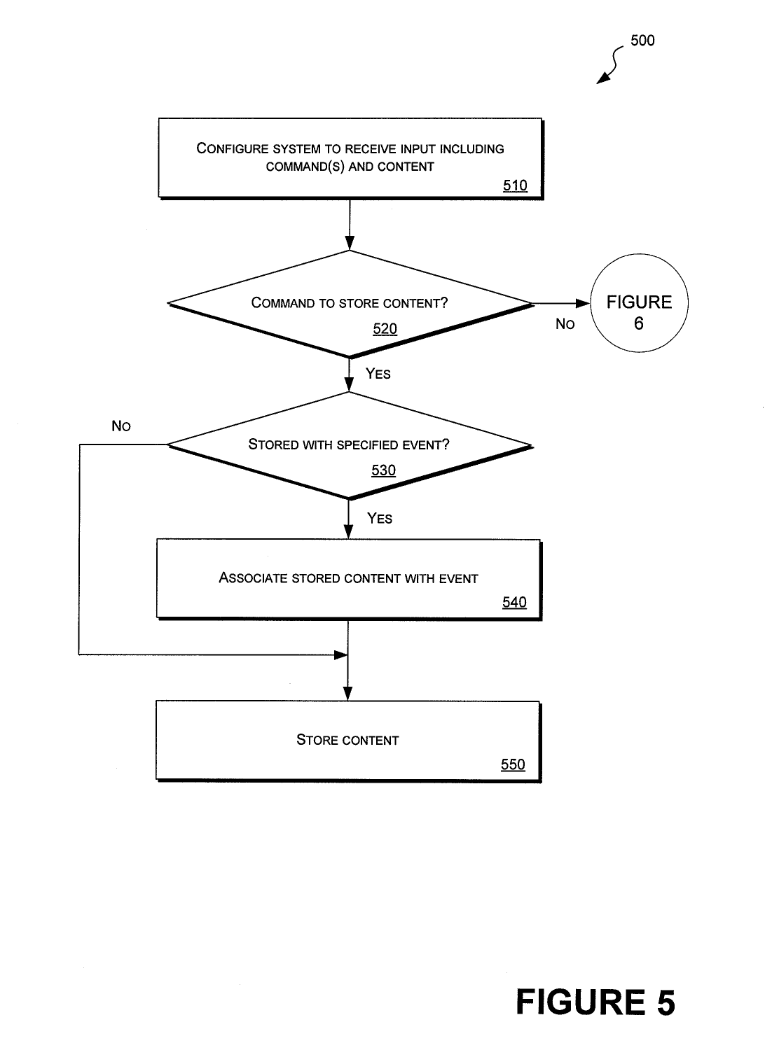

FIG. 5 presents a flow diagram 500 illustrating an example of the operation of a computer-implemented method of cognitive offloading, a computer-readable storage medium storing instructions allowing a computer system to perform cognitive offloading, and a system configured to support cognitive offloading.

At 510, a system is configured to receive content including one or more commands and other content. As previously described, one implementation of cognitive offloading uses a verbal interface to receive auditory content from a user and playback auditory content to the user. However, cognitive offloading may likewise be applied for the storage and retrieval of other information.

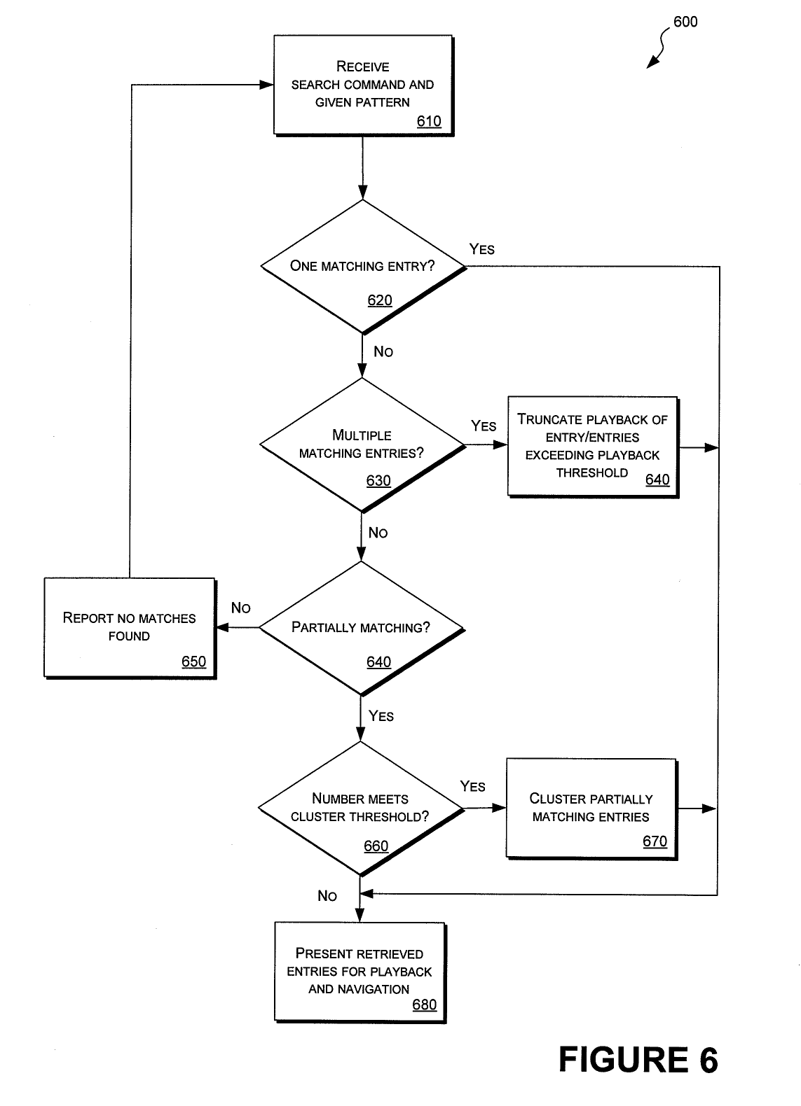

At 520, it is determined if the command is directed to storing content. If not, the flow diagram 500 proceeds to FIG. 6 where processes for retrieving and presenting information are described. On the other hand, if it is determined at 520 that the command is directed to storing content, at 530, it is determined if the content be stored is to be stored in association with a specified event. If so, at 540, the stored content is associated with the event so that the content will be retrieved when the event occurs. If it is determined at 530 the content is not to be stored in association with a specified event or once the content is associated with the event, at 550, the content is stored in the form of one or more entries, for example, in a digitized form. As previously described, content may be received in the form of a single entry and, thus stored as a single entry. On the other hand, if content is received as a series of sub-entries delimited by pauses, for example, the series of sub-entries will be stored as separate but related content entries.

FIG. 6 presents a flow diagram 600 illustrating an example of the retrieval of previously stored content. At 610, a search command and a given pattern representing the search terms are received. At 620, it is determined if the search of the stored content has retrieved a single matching entry. If so, the flow diagram 600 proceeds to 680 to present the retrieved entry for playback and navigation. On the other hand, if it is determined at 620 that there is not just one matching entry, at 630, it is determined if there are multiple matching entries. If so, at 640, of any entry or entries among the multiple matching entries exceeding a playback threshold are truncated for initial presentation to the user.

If it is determined at 620 that there is no single matching entry at 630 that there are not multiple matching entries, at 640, it is determined if there are any partially matching entries. If not, at 650, it is reported to the user that no matches have been found. At this point, the flow diagram 600 may flow to 610 to receive another search command. On the other hand, if it is determined at 640 that at least one partial matches been found, at 660, it is determined if the number of partial matches if the clustered threshold. If so, at 670, the partially matching entries are clustered into groups to allow the user which of the clusters to review further. At 680, the retrieved entry or entries are presented to the user for playback and navigation.

The processes illustrated in the flow diagrams 500 and 600 may cycle repeatedly as desired.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-implemented method, comprising:
configuring a system equipped with an auditory input device and an auditory output device to receive auditory content, including:
one or more verbal commands configured to cause the auditory content to be stored for retrieval; and
the auditory content including one of:
event-triggered content stored for retrieval upon an occurrence of a specified event; and
other content;
storing the auditory content as one or more content entries;
retrieving desired auditory content in response to one of:
a retrieval command specifying a given pattern, including:
comparing the given pattern with the one or more content entries; and
upon finding a match for the given pattern in the content entries, wherein the match corresponds with the given pattern within a predetermined variance, retrieving additional content stored with the match for the given pattern; and
identifying the occurrence of the specified event and retrieving the event-triggered content stored for retrieval upon the occurrence of the specified event; and
presenting the desired auditory content via the auditory output device.

2. The computer-implemented method of claim 1, further comprising configuring the system to receive the auditory content upon one of:
the auditory input device receiving a key phrase; and
activation of a receive switch.

3. The computer-implemented method of claim 1, wherein the specified event includes one of:
a passage of a specified period of time; and
reaching a specified time including at least one of a time of day and a date.

4. The computer-implemented method of claim 1, wherein the specified event includes one of:
a user being present at a previously-specified location;
a specified environmental condition;
a physical condition of the user;
receipt of a communication from a previously-specified source;
receiving a communication including a specified element of information; and
presence of a previously-identified object or person.

5. The computer-implemented method of claim 1, wherein the auditory content stored includes one of:
a single entry; and
a plurality of entries delimited by pauses, wherein each of plurality of entries is separately retrievable in response to a retrieval directive.

6. The computer-implemented method of claim 5, wherein the plurality of entries are associated with an implied subject identified by a first entry set off by a first pause.

7. The computer-implemented method of claim 1, further comprising when, in response to the retrieval command, a plurality of partial matches are found for the given pattern:
retrieving the plurality of partial matches as entries in a result list; and
presenting the result list in an order according to which of the plurality of partial matches most nearly matches the given pattern.

8. The computer-implemented method of claim 7, further comprising, when a number of entries in the result list exceeds a threshold number, grouping the plurality of partial matches into a plurality of clusters presented as the plurality of partial matches with a specified part of the given pattern.

9. The computer-implemented method of claim 7, further comprising assigning numbers to one of each of the entries in the result list plurality allowing the user to select from the plurality of partial matches by the assigned number.

10. The computer-implemented method of claim 7, further comprising providing a plurality of navigational commands allowing the user to speak a command including:
a next command to navigate to the next entry in the result list;
a previous command to navigate to a last-presented entry in the result list; and
one or more action commands configured to perform a specified action on the currently presented entry in the result list.

11. The computer-implemented method of claim 7, further comprising, when one or more of the entries in the result list exceeds a threshold playback length, truncating playback of the one or more entries after predetermined interval.

12. The computer-implemented method of claim 1, further comprising upon presenting the desired auditory content via the auditory output device in response to a retrieval command, omitting a portion of the desired auditory content including the given pattern.

13. A computer-readable storage medium storing instructions executable by a computing system to generate a result, comprising instructions to:
process content including:
one or more commands configured to cause the content to be stored for retrieval; and
the content including one or more entries including one of:
event-triggered content stored for retrieval upon an occurrence of a specified event; and
other content; and
retrieving desired content in response to one of:
a retrieval command specifying a given pattern, including:
comparing the given pattern with the stored content; and
upon finding a match for the given pattern among the stored content, wherein the match corresponds with the given pattern within a predetermined variance, retrieving additional content stored with the match for the given pattern; and
identifying the occurrence of the specified event and retrieving the event-triggered content stored for retrieval upon the occurrence of the specified event.

14. The computer-readable medium of claim 13, wherein the one or more commands configured to cause the content to be stored for retrieval and the retrieval command each are initiated by one of more of:
a verbal command; and
activation of a physically-actuated switch.

15. The computer-readable medium of claim 13, further comprising when, in response to the retrieval command, a plurality of partial matches are found for the given pattern:
retrieving the plurality of partial matches as entries in a result list; and
presenting the result list in an order according to which of the plurality of partial matches most nearly matches the given pattern; and
assigning numbers to one of each of the entries in the result list.

16. The computer-readable medium of claim 15, further comprising providing a plurality of navigational commands, including:
a next command to navigate to the next entry in the result list;
a previous command to navigate to a last-presented entry in the result list;
a number command to navigate one of the plurality of partial matches by the assigned number; and
one or more action commands configured to perform a specified action on the currently presented entry in the result list.

17. A wearable system for cognitive offloading, comprising:
a processor;
a storage device;
an auditory input device in communication with the processor and the storage device allowing the processor to receive auditory input and perform operations in the storage device using the auditory content;
an auditory output device configured to translate output generated by the processor into auditory output; and
operating instructions configured to:
process one or more verbal commands configured to cause the auditory content to be stored as auditory data;
retrieve desired auditory content in response to one of:
a retrieval command specifying a given auditory pattern, including:
comparing the given auditory pattern with stored auditory data; and
upon finding a match for the given auditory pattern in the stored auditory data, wherein the match corresponds with the given auditory pattern within a predetermined variance, retrieving additional auditory data stored with the match for the given auditory pattern; and
the occurrence of a specified event associated with the auditory content.

18. The system of claim 17, further comprising configuring the system to receive the auditory data upon one of:
the auditory input device receiving a key phrase; and
activation of a receive switch.

19. The system of claim 17, further comprising one or more detection devices to identify an occurrence identified as the specified event, including:
a clock configured to measure the passage of time to allow the system to identify one of:
passage of a specified period of time; and
reaching a specified time;
a global positioning sensor configured to allow the system to identify arrival at a location;
an atmospheric condition sensor configured to allow the system to recognize a status of an atmospheric condition;
a physical condition sensor configured to allow the system to recognize a physical condition of a wearer of the system;
a call identification sensor configured to allow identification of a telephone number of an incoming call;
a receiving device configured to receive information and allow identification of a specified element of information included in the information received; and
a visual sensor configured to allow recognition of an element in proximity to the system.

20. The system of claim 17, wherein the wearable device includes a wireless telephone earpiece configured to communicate with a wireless telephone device.
